(19) United States
(12) Patent Application Publication
(10) Pub. No.: US 2009/0024941 A1
(43) Pub. Date: Jan. 22, 2009

(54) APPARATUS, METHOD, AND COMPUTER PROGRAM PRODUCT FOR PROCESSING INFORMATION

(75) Inventor: Shigeaki Sakurai, Tokyo (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/173,443

(22) Filed: Jul. 15, 2008

(30) Foreign Application Priority Data
Jul. 20, 2007 (JP) 2007-189451

(51) Int. Cl. G06F 3/01

(52) U.S. Cl. 715/763

(57) ABSTRACT

By using event extracting knowledge, a plurality of events are extracted from a text. One of the events is extracted as a targeting event, and also one or more of the events other than the targeting event are extracted as targeted events, so that one or more combinations of the targeting event and the one or more targeted events are generated. A distance between a first text and a second text from which one or more of the combinations have been generated is calculated, so that a certainty factor of each of the combinations is calculated. One of the combinations is selected based on the certainty factors, so that the selected combination is displayed.

### CROSS-REFERENCE TO RELATED APPLICATIONS

This application is based upon and claims the benefit of priority from the prior Japanese Patent Application No. 2007-189451, filed on Jul. 20, 2007; the entire contents of which are incorporated herein by reference.

### BACKGROUND OF THE INVENTION

1. Field of the Invention

The present invention relates to an apparatus, a method, and a computer program product for processing information that are used for extracting an event by which the contents of a text is characterized, out of a text set including a plurality of texts each of which is made of a character string and that can be arranged in an order.

2. Description of the Related Art

There are a large number of bulletin board sites on the Web, and an innumerable number of discussions are developed on these sites on a daily basis. Not a few of these discussions are developed into serious discussions that may influence corporate activities. Thus, there is a demand for methods that can be used to analyze series texts (i.e., a text set) that have an ordinal structure containing a plurality of texts that correspond to these discussions and that can be arranged in an order. One example of such methods is described in Shigeaki Sakurai and Ryohei Orihara: “Discovery of Important Threads from Bulletin Board Sites”, International Journal of Information Technology and Intelligent Computing, 1, 1, 217-228 (2006). According to the method described in this document, characteristic contents that represent each text are defined as events so that it is judged, for each of the texts, whether any event is present in the text. Thus, each of the texts is characterized by a plurality of events so that it is possible to find discussions to which attention should be paid. Also, another method is proposed in JP-A 2003-271609 (KOKAI) by which a reputation extracting rule is structured with an extracted intention that is obtained by categorizing the intention of the writer of a sentence and an intention extracting expression indicating a characteristic expression for the extracted intention. By using the reputation extracting rule, a reputation expression is extracted out of the sentences found in a search, so that web sites to which attention should be paid are detected according to the number of reputation expressions that have been extracted. Further, yet another method is proposed in JP-A 2004-185135 (KOKAI) by which topics that are selected from each section are arranged on a temporal axis so that two or more topics that have a characteristic keyword in common are connected to one another, and changes in the topics can be extracted.

However, according to the method described in the document by Shigeaki Sakurai and Ryohei Orihara, because the events are extracted from the text independently of one another, the correspondence relationships among the plurality of events that have been extracted out of the texts are not clear. Thus, there is a possibility that the discussions to which attention should be paid may be found based on a wrong correspondence relationship among the events. Further, according to the method proposed in JP-A 2003-271609 (KOKAI), it is not possible to explicitly treat the relationship between the reputation expression and the subject matter of the reputation expression. Thus, in the case where a text describes a plurality of reputation expressions and a plurality of subject matters, there is a possibility that it may not be possible to detect the web sites to which attention should be paid while the correspondence relationships among the reputation expressions and the subject matters are taken into consideration. Furthermore, according to the method proposed in JP-A 2004-185135 (KOKAI), the focus is placed only on the temporal transitions of the topics having a characteristic keyword in common. Thus, it is not possible to extract the correspondence relationship among other topics that do not have any characteristic keyword in common. Consequently, there is a demand for being able to analyze series texts that have an ordinal structure like discussions on a bulletin board site, while the correspondence relationship among a plurality of events that have been extracted out of the series texts are taken into consideration.

### SUMMARY OF THE INVENTION

According to one aspect of the present invention, an information processing apparatus includes an obtaining unit that obtains a text from a text set including a plurality of texts each of which is constituted by a character string and that can be arranged in an order; a first storage unit that stores an event extracting knowledge used for extracting from the text a plurality of events by which contents of the text are characterized; an extracting unit that extracts a plurality of events from the obtained text by using the event extracting knowledge; a generating unit that extracts one of the events from the plurality of events extracted from the text as a targeting event, extracts one or more of the events other than the targeting event as targeted events, and generates one or more combinations of the targeting event and the targeted events; a calculating unit that calculates a distance indicating a difference in closeness in terms of the order between a first text from which the combination has been generated and a second text from which the combination has been generated, and calculates, for each of the combinations, a certainty factor indicating a degree of certainty of the combination of the targeting event and the targeted event in such a manner that the shorter the distance is, the higher a value of the certainty factor is; a selecting unit that selects, as a combination for the text set, one of a first combination and a second combination, the first combination having the certainty factor calculated by the calculating unit that is equal to or larger than a threshold value, and the second combination having the certainty factor placed in an ordinal rank equal to or lower than a predetermined ordinal rank; and a display controlling unit that causes a displaying unit to display the selected combination.

According to another aspect of the present invention, an information processing method includes obtaining, by an obtaining unit of an information processing apparatus, a text from a text set including a plurality of texts each of which is constituted by a character string and that can be arranged in an order; extracting, by an extracting unit of the information processing apparatus, from the obtained text a plurality of events by using the event extracting knowledge used for extracting from the text the event that is stored in a first storage unit and characterizes contents of the text; extracting, by a generating unit of the information processing apparatus, one of the events from the plurality of events extracted from the text as a targeting event, extracting one or more of the events other than the targeting event as targeted events, and generating one or more combinations of the targeting event and the targeted events; calculating, by a calculating unit of the information processing apparatus, a distance indicating a difference in closeness in terms of the order between a first text from which the combination has been generated and a second text from which the combination has been generated, and calculating, for each of the combinations, a certainty factor indicating a degree of certainty of the combination of the targeting event and the targeted event in such a manner that the shorter the distance is, the higher a value of the certainty factor is; selecting, by a selecting unit of the information processing apparatus, as a combination for the text set, one of a first combination and a second combination, the first combination having the certainty factor calculated by the calculating unit that is equal to or larger than a threshold value, and the second combination having the certainty factor placed in an ordinal rank equal to or lower than a predetermined ordinal rank; and causing, by a display controlling unit of the information processing apparatus, a displaying unit to display the selected combination.

A computer program product according to still another aspect of the present invention causes a computer to perform the method according to the present invention.

### BRIEF DESCRIPTION OF THE DRAWINGS

FIG. 1 is a block diagram of an example of an internal configuration of an information processing apparatus;

FIG. 2 is a drawing illustrating an example of series texts;

FIG. 3 is a drawing illustrating an example of pieces of event extracting knowledge;

FIG. 4 is a flowchart of a procedure in an event relationship finding process;

FIG. 5 is a drawing illustrating examples of events assigned to the element texts shown in FIG. 2;

FIG. 6 is a flowchart of a procedure in a process to calculate certainty factors for candidate event pairs;

FIG. 7 is a drawing illustrating normalized certainty factors of candidate event pairs;

FIG. 8 is another drawing illustrating normalized certainty factors of candidate event pairs; and

FIG. 9 is a drawing illustrating an example in which event pairs are displayed.

### DETAILED DESCRIPTION OF THE INVENTION

The hardware configuration of an information processing apparatus 1 according to an exemplary embodiment of the present invention will be explained. The information processing apparatus 1 includes: a Central Processing Unit (CPU); a storage unit that stores therein various types of computer programs and various types of data like images and that includes a Read-Only memory (ROM) and/or a Random Access Memory (RAM) and/or a Hard Disk Drive (HDD); a communicating unit; and a bus (not shown) that connects these elements (not shown) to one another. Also, a display device (not shown) and an input device (not shown) like a keyboard and/or a mouse are connected to the information processing apparatus 1. The display device may be configured with, for example, a Cathode Ray Tube (CRT) or a liquid crystal display monitor. The input device includes operating keys, operating buttons, and the mouse to which the operations of the user are input.

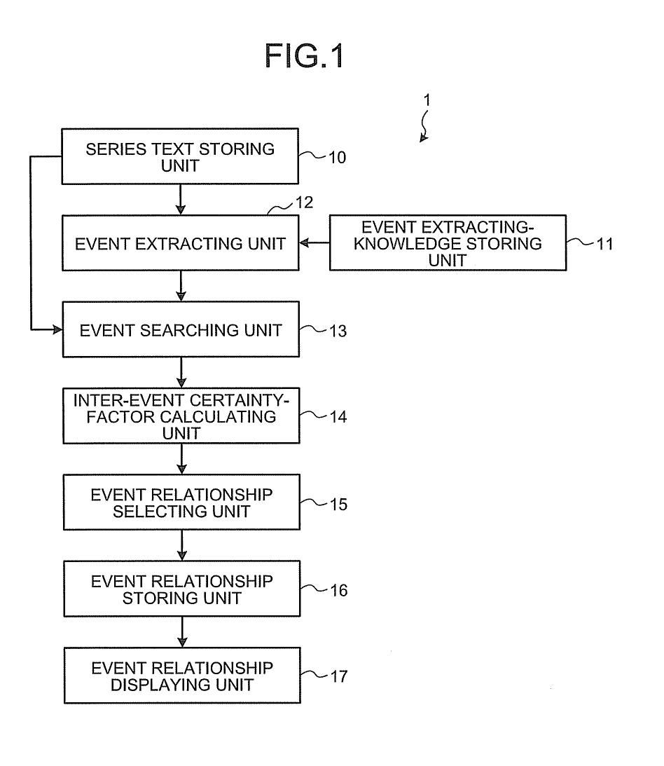

Next, an internal configuration of the information processing apparatus 1 will be explained. FIG. 1 is a block diagram of an example of the internal configuration of the information processing apparatus 1 according to the present embodiment. The information processing apparatus 1 includes a series text storing unit 10, an event extracting-knowledge storing unit 11, an event extracting unit 12, an event searching unit 13, an inter-event certainty-factor calculating unit 14, an event relationship selecting unit 15, an event relationship storing unit 16, and an event relationship displaying unit 17. Of these units, the event extracting unit 12, the event searching unit 13, the inter-event certainty-factor calculating unit 14, the event relationship selecting unit 15, and the event relationship displaying unit 17 are realized when the CPU of the information processing apparatus 1 executes the various types of computer programs stored in the storage unit. The series text storing unit 10, the event extracting-knowledge storing unit 11, and the event relationship storing unit 16 are realized with the storage unit.

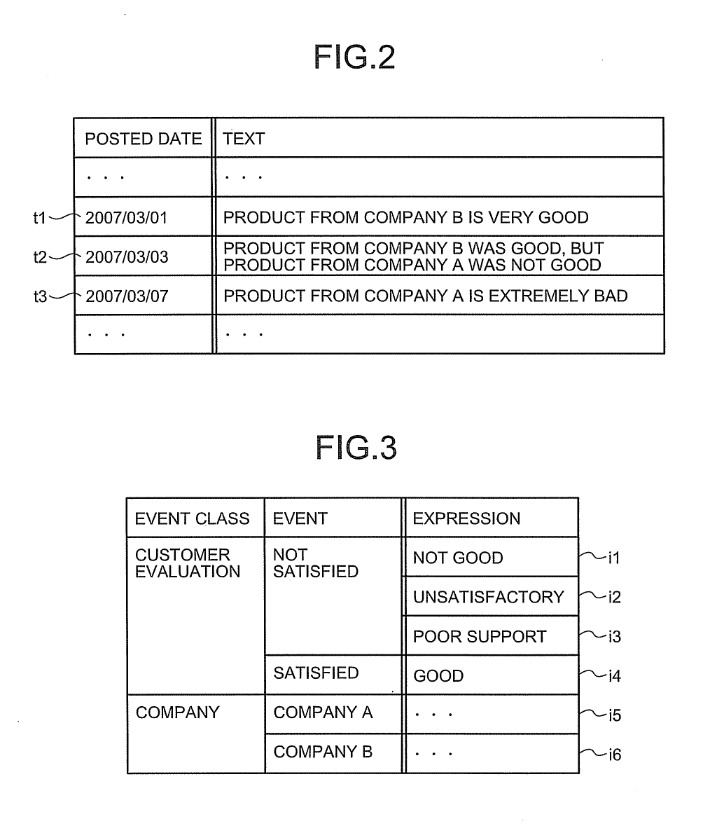

The series text storing unit 10 stores therein series texts. The series texts are, for example, texts that include element texts each of which is made up of order information and a text, the element texts being arranged in an order based on the order information. FIG. 2 is a drawing illustrating an example of series texts. In FIG. 2, the dates on which the texts have been posted (hereinafter, the “posted dates”) serve as the order information. Each set made up of a posted date and a text corresponds to an element text.

The event extracting-knowledge storing unit 11 stores therein pieces of event extracting knowledge. The event extracting unit 12 reads the series texts stored in the series text storing unit 10, judges whether each of the element texts contained in the series texts includes one or more specific events by using the pieces of event extracting knowledge stored in the event extracting-knowledge storing unit 11, and extracts one or more events included in the element texts. In this situation, what the contents of the text are characterized by is defined as an “event”. FIG. 3 is a drawing illustrating an example of pieces of event extracting knowledge. To obtain the pieces of event extracting knowledge, a dictionary that is made up of “event classes”, “events”, and “expressions” as shown in the drawing may be used. In this situation, each of the event classes is obtained by categorizing mutually the same type of events together. The expressions represent the contents of the events written in the text. In the example shown in the drawing, each line corresponds to one piece of event extracting knowledge. For example, the event extracting unit 12 extracts, as a piece of event knowledge, a set made up of an “event class”, an “event”, and an “expression” or a set made up of an “event class” and an “event”. For example, the event extracting unit 12 may extract any of the following as a piece of event knowledge: a set (i1) made up of “customer evaluation”, “not satisfied”, and “not good”; a set (i2) made up of “customer evaluation”, “not satisfied”, and “unsatisfactory”; a set (i3) made up of “customer evaluation”, “not satisfied”, and “poor support”; a set (i4) made up of “customer evaluation”, “satisfied”, and “good”; a set (i5) made up of “company” and “company A”; and a set (i6) made up of “company” and “company B”. The event extracting unit 12 may extract “not satisfied”, “satisfied”, “company A”, and “company B” as the events.

Further, it is possible to use, as the event extracting knowledge, a classification model that is learned in an inductive manner by using the method described in the document by Shigeaki Sakurai and Ryohei Orihara: “Discovery of Important Threads from Bulletin Board Sites”, International Journal of Information Technology and Intelligent Computing, 1, 1, 217-228 (2006).

In the case where the one of the element texts that has been extracted by the event extracting unit 12 includes a plurality of events, the event searching unit 13 generates combinations of the events as candidate event pairs. In this situation, the candidate event pairs are generated for each of the element texts.

The inter-event certainty-factor calculating unit 14 calculates a distance indicating a difference in the closeness in terms of the order in which the one of the element texts that has been extracted by the event extracting unit 12 and another one of the element texts that includes any of the candidate event pairs generated by the event searching unit 13 are arranged. The inter-event certainty-factor calculating unit 14 then calculates a certainty factor for each of the candidate event pairs, based on the calculated distance. The certainty factor indicates a degree of certainty of each of the combinations of events. The shorter the distance is, the higher the value of the certainty factor is. In this situation, the certainty factor of each of the candidate event pairs is calculated for each of the element texts.

The event relationship selecting unit 15 selects, out of the candidate event pairs, an event pair having a high certainty factor as an event pair for the series texts, based on the certainty factors that have been calculated by the inter-event certainty-factor calculating unit 14. The event relationship selecting unit 15 then stores the selected event pair into the event relationship storing unit 16.

The event relationship displaying unit 17 causes the display device to display the event pair stored in the event relationship storing unit 16.

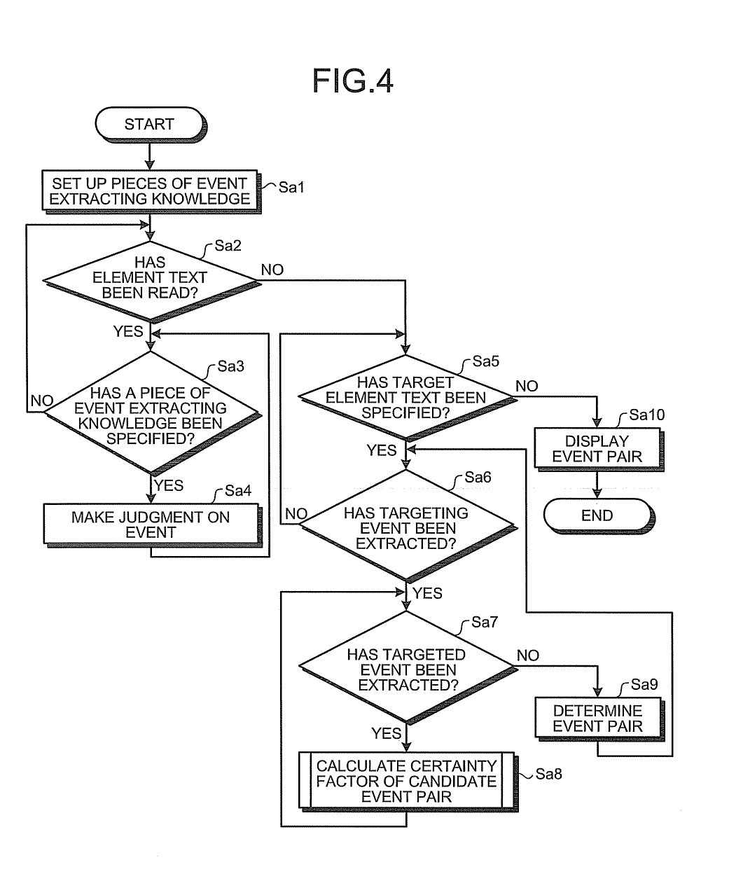

Next, a procedure in an event relationship finding process performed by the information processing apparatus 1 will be explained. FIG. 4 is a flowchart of the procedure in the event relationship finding process. At step Sa1, the event extracting unit 12 included in the information processing apparatus 1 reads and sets up all the pieces of event extracting knowledge that are stored in the event extracting-knowledge storing unit 11. After that at step Sa2, the event extracting unit 12 reads one of the element texts that are included in the series texts and that has not been read yet, from the series text storing unit 10. For instance, in the example shown in FIG. 2, one of the element texts t1, t2, and t3 is read. In this situation, if there is no element text to be read, the process proceeds to step Sa5. On the contrary, if there is an element text to be read, the process proceeds to step Sa3.

At step Sa3, the event extracting unit 12 extracts one of the pieces of event extracting knowledge that have been set up at step Sa1 and that has not been extracted yet. For instance, one of the pieces of event extracting knowledge i1 to i6 shown in FIG. 3 is extracted. In this situation, if there is no piece of event extracting knowledge to be extracted, the process returns to step Sa2. On the contrary, if there is a piece of event extracting knowledge to be extracted, the process proceeds to step Sa4.

At step Sa4, by applying the piece of event extracting knowledge that has been extracted at step Sa3 to the element text that has been read at step Sa2, the event extracting unit 12 judges whether the event corresponding to the piece of event extracting knowledge should be assigned to the element text. More specifically, the event extracting unit 12 judges whether the word or the phrase in the “event” or the “expression” in the piece of event extracting knowledge is included in the element text. For example, in the case where the element text t1 shown in FIG. 2 has been read at step Sa2, and the piece of event extracting knowledge i4 has been extracted at step Sa3, the element text t1 does not include the phrase “not good” as an “expression”. Thus, the event extracting unit 12 judges that the event “not satisfied” should not be assigned to the element text t1. As another example, in the case where the element text t1 has been read, and the piece of event extracting knowledge i6 has been extracted at step Sa3, the element text t1 includes the phrase “company B” as an “event”. Thus, the event extracting unit 12 judges that the event “company B” should be assigned to the element text t1. In the manner described above, for example, the event extracting unit 12 judges whether the event corresponding to the piece of event extracting knowledge that has been extracted at step Sa3 should be brought into correspondence with the element text that has been read at step Sa2. In the case where the result of the judgment process at step Sa4 is in the affirmative, the event extracting unit 12 assigns the event to the element text and stores the element text with the assigned event into the series text storing unit 10. After that, the process returns to step Sa3. On the contrary, in the case where the result of the judgment process at step Sa4 is in the negative, the event extracting unit 12 assigns no event to the element text, and the process returns to step Sa3.

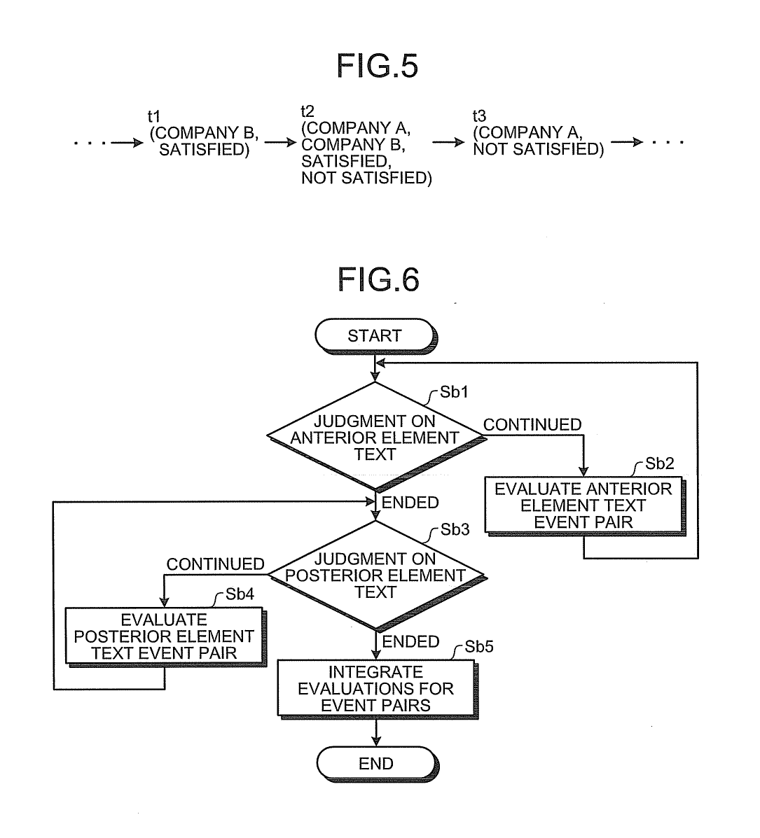

FIG. 5 is a drawing illustrating examples of events assigned to the element texts shown in FIG. 2. In FIG. 5, two events that are namely “company B” and “satisfied” are assigned to the element text t1. Also, four events that are namely “company A”, “company B”, “satisfied”, and “not satisfied” are assigned to the element text t2. Further, two events that are namely “company A” and “not satisfied” are assigned to the element text t3.

As a result of the processes described above, the event extracting unit 12 judges, for each of the pieces of event extracting knowledge, whether any event should be assigned to the one of the element texts that are included in the series texts, by using all the pieces of event extracting knowledge and assigns one or more events to the element text according to the result of the judgment process. When the process described above has been performed on each of all the element texts that are included in the series texts, the result of the judgment process at step Sa2 is in the negative, and the process proceeds to step Sa5.

At step Sa5, the event searching unit 13 extracts one of the element texts that are included in the series texts stored in the series text storing unit 10, as a target element text. In this situation, if there is no element text to be extracted, the process proceeds to step Sa10. On the contrary, if there is an element text to be extracted, the process proceeds to step Sa6.

At step Sa6, the event searching unit 13 extracts one of the events that have been assigned to the target element text and that has not been extracted yet as a targeting event. In this situation, if there is no targeting event to be extracted, the process returns to step Sa5. On the contrary, if there is a targeting event to be extracted, the process proceeds to step Sa7.

At step Sa7, the event searching unit 13 extracts another one of the events that have been assigned to the target element text and that is different from the event extracted at step Sa6 and has not yet been extracted to be paired with the event extracted at step Sa6, as a targeted event. In this situation, if there is a targeted event to be extracted, the event searching unit 13 generates a candidate event pair in which the targeting event extracted at step Sa6 is paired with the targeted event, and the process proceeds to step Sa8.

For instance, in an example in which the events that are shown in FIG. 5 have been extracted, and the element text t1 shown in FIG. 2 is the target element text, in the case where the candidate event pair is expressed by using the form (a targeting event, a targeted event), (company B, satisfied) is generated as a candidate event pair. In an example in which the element text t2 is the target element text, (company A, satisfied), (company A, not satisfied), (company B, satisfied), (company B, not satisfied), (company A, company B), (satisfied, not satisfied) are generated as candidate event pairs. In an example in which the element text t3 is the target element text, (company A, satisfied) is generated as a candidate event pair.

In other words, at step Sa7, for each of the target element texts, a combination of the events included in the target element text is generated as a candidate event pair. As a result of repeatedly performing the process at step Sa7 on the one target element text, all the possible combinations of the events are generated as the candidate event pairs.

At step Sa8, the inter-event certainty-factor calculating unit 14 extracts an anterior element text and a posterior element text that includes any of the candidate event pairs that have been generated at step Sa7, by referring to an anterior element text set that is made up of the element texts positioned anterior to the target element text and a posterior element text set that is made up of the element texts positioned posterior to the target element text. In this situation, the term “anterior” means that the posted date that is included in the element text and serves as the order information indicates an older date, whereas the term “posterior” means that the posted date that serves as the order information indicates a more recent date. However, the opposite may be applied to the present embodiment. The inter-event certainty-factor calculating unit 14 calculates a distance between the target element text and the extracted anterior element text and a distance between the target element text and the extracted posterior element text. The inter-event certainty-factor calculating unit 14 then calculates the certainty factor of each of the candidate event pairs for the target element text, based on the calculated distances.

FIG. 6 is a flowchart of a procedure in the process to calculate the certainty factors for the candidate event pairs. At step Sb1, the inter-event certainty-factor calculating unit 14 extracts one element text that is positioned anterior to the target element text and has not been extracted yet as an anterior element text. In this situation, if there is no anterior element text to be extracted, the process proceeds to step Sb3. On the contrary, if there is an anterior element text to be extracted, the process proceeds to step Sb2.

In this situation, it is possible to select any of the element texts that are positioned anterior to the target element text, as the element text to be extracted that has not been extracted yet. Another arrangement is acceptable in which it is possible to select only such anterior element texts of which the distance from the target element text is within a predetermined anterior target distance, as the element text to be extracted. In the present embodiment, the distance is calculated by using the posted dates that are included as the order information in the element texts, so that the difference in the dates is used as the distance between the element texts.

At step Sb2, the inter-event certainty-factor calculating unit 14 judges whether the extracted anterior element text includes any of the candidate event pairs. In this situation, in the case where the extracted anterior element text includes none of the candidate event pairs, the certainty factors of the candidate event pairs for the target element text are not updated, and the process returns to step Sb1. On the contrary, in the case where the extracted anterior element text includes one or more of the candidate event pairs, the inter-event certainty-factor calculating unit 14 calculates a certainty factor (hereinafter, an “anterior inter-element-text certainty factor”) between the target element text and the anterior element text by using, for example, Formula (1). After that, the inter-event certainty-factor calculating unit 14 adds the calculated certainty factor to the certainty factors of the candidate event pairs for the target element text, and the process returns to step Sb1.

$$ANTERIOR INTER \text{-} ELEMENT - TEXT CERTAINTY FACTOR = 1 - \frac{\begin{matrix}DIFFERENCE IN DATES FROM \\ ANTERIOR ELEMENT TEXT\end{matrix} }{ANTERIOR TARGET DISTANCE} \qquad ( 1 )$$

In Formula (1), the “anterior target distance” denotes a maximum date difference that is specified in advance for the difference between the target element text and an anterior element text. Accordingly, no anterior element text of which the difference is larger than the maximum date difference is extracted at step Sb1. In the present example, the maximum date difference is set so as to be ten days.

For instance, let us discuss an example in which the element text t1 is the target element text, and (company B, satisfied) is generated as a candidate event pair at step Sa7. In this situation, because an anterior element text of the element text t1 does not exist, the anterior element text does not include the candidate event pair. Thus, the certainty factor of the candidate event pair for the target element text is not updated, and the process returns to step Sb1.

Let us discuss another example in which the element text t2 is the target element text, and (company B, satisfied) is generated as a candidate event pair at step Sa7. In this situation, the element text t1 serving as an anterior element text includes the candidate event pair. Thus, an anterior inter-element-text certainty factor is calculated by using Formula (1). As shown in FIG. 2, the posted date of the element text t1 is “Mar. 1, 2007”, whereas the posted date of the element text t2 is “Mar. 3, 2007”, and the difference between the dates is two days. Thus, the anterior inter-element-text certainty factor is calculated as “0.8=1-2/10”. Accordingly, “0.8” is added to the certainty factor of the candidate event pair for the target element text.

In this manner, the process described above is performed on each of all the element texts that are positioned anterior to the target element text. When the process has been performed on each of all the anterior element texts, the process proceeds to step Sb3.

At step Sb3, the inter-event certainty-factor calculating unit 14 extracts, as a posterior element text, one of the element texts that are positioned posterior to the target element text and that has not been extracted yet. In this situation, if there is no posterior element text to be extracted, the process proceeds to step Sb5. On the contrary, if there is a posterior element text to be extracted, the process proceeds to step Sb4.

At step Sb4, the inter-event certainty-factor calculating unit 14 judges whether the extracted posterior element text includes any of the candidate event pairs. In this situation, in the case where the posterior element text includes none of the candidate event pairs, the certainty factors of the candidate event pairs for the target element text are not updated, and the process returns to step Sb1. On the contrary, in the case where the extracted posterior element text includes one or more of the candidate event pairs, the inter-event certainty-factor calculating unit 14 calculates a certainty factor (hereinafter, a “posterior inter-element-text certainty factor”) between the target element text and the posterior element text by using, for example, Formula (2). After that, the inter-event certainty-factor calculating unit 14 adds the calculated certainty factor to the certainty factors of the candidate event pairs for the target element text, and the process returns to step Sb1.

$$POSTERIOR INTER \text{-} ELEMENT - TEXT CERTAINTY FACTOR = 1 - \frac{\begin{matrix}DIFFERENCE IN DATES FROM \\ POSTERIOR ELEMENT TEXT\end{matrix}}{POSTERIOR TARGET DISTANCE} \qquad ( 2 )$$

In Formula (2), the “posterior target distance” denotes a maximum date difference that is specified in advance for the difference between the target element text and a posterior element text. Accordingly, no posterior element text of which the difference is larger than the maximum date difference is extracted at step Sb1. In the present example, the maximum date difference is set so as to be ten days.

For instance, let us discuss an example in which the element text t2 is the target element text, and (company B, not satisfied) is generated as a candidate event pair at step Sa7. In this situation, the element text t3 serving as a posterior element text does not include the candidate event pair. Thus, the certainty factor of the candidate event pair for the target element text is not updated, and the process returns to step Sb1.

Let us discuss another example in which the element text t2 is the target element text, and (company A, not satisfied) is generated as a candidate event pair at step Sa7. In this situation, the element text t3 serving as a posterior element text includes the candidate event pair. Thus, a posterior inter-element-text certainty factor is calculated by using Formula (2). As shown in FIG. 2, the posted date of the element text t2 is “Mar. 3, 2007”, whereas the posted date of the element text t3 is “Mar. 3, 2007”, and the difference between the dates is four days. Thus, the posterior inter-element-text certainty factor is calculated as “0.6=1−4/10”. Accordingly, “0.6” is added to the certainty factor of the candidate event pair for the target element text.

In this manner, the process described above is performed on each of all the element texts that are positioned posterior to the target element text. When the process has been performed on each of all the posterior element texts, the process proceeds to step Sb5.

At step Sb5, the inter-event certainty-factor calculating unit 14 normalizes the certainty factors that have been calculated for the candidate event pairs with respect to the target element text and updates the certainty factors of the candidate event pairs for the target element text. For example, if it is assumed that the anterior maximum date difference and the posterior maximum date difference are each set so as to be ten days, and that the number of element texts for any single day is one at most, it is possible to calculate the maximum value for the certainty factor of each of the candidate event pairs by using Formula (3).

10(=2*(Σᵢ₌₁ⁿ0.1*i)+1.0) (3)

In Formula (3), because the candidate event pair is included at least in the target element text, the minimum value is “1.0”. In other words, before being normalized, the certainty factor of a candidate event pair that is included in only one element text and is not included in any of the anterior element texts and the posterior element texts is “1.0”.

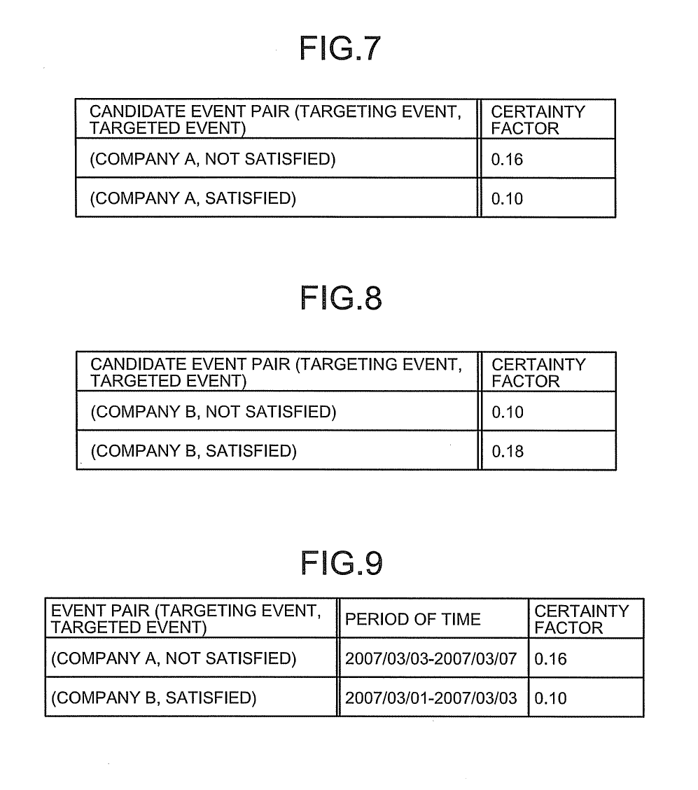

For example, in the case where the element text t2 is the target element text, and the targeting event is “company A”, if only the events shown in FIG. 5 are considered, (company A, not satisfied), (company A, satisfied), and (company A, company B) are the only candidate event pairs for the targeting event “company A”. The certainty factors of these candidate event pairs are “1.6”, “1.0”, and “1.0”, respectively. FIG. 7 is a drawing illustrating normalized certainty factors of the candidate event pairs (company A, not satisfied) and (company A, satisfied). As shown in FIG. 7, the normalized certainty factors are “0.16” and “0.10”, respectively.

As another example, in the case where the element text t2 is the target element text, and the targeting event is “company B”, (company B, not satisfied) and (company B, satisfied) are the only candidate event pairs for the targeting event “company B”. The certainty factors of these candidate event pairs are “1.0” and “1.8”, respectively. As shown in FIG. 8, normalized certainty factors are “0.10” and “0.18”, respectively. These normalized certainty factors are stored into the storage unit in the form of a table or the like.

As explained above, the event searching unit 13 selects one of the events assigned to the target element text as a targeting event and generates a combination of the targeting event and another one of the events that has not yet been extracted and is to be paired with the targeting event, as a candidate event pair. After that, the inter-event certainty-factor calculating unit 14 calculates the certainty factor for the candidate event pair. When the certainty factor of each of all the candidate event pairs has been calculated, the process proceeds to step Sa9 shown in FIG. 4.

At step Sa7, if there is no targeted event to be extracted, the process proceeds to step Sa9. At step Sa9, the event relationship selecting unit 15 refers to the certainty factors of the candidate event pairs that have been calculated at steps Sa8 and determines a targeted event that should be paired with the targeting event. The event relationship selecting unit 15 then stores the pair (hereinafter, an “event pair”) in which the targeting event is paired with the targeted event into the event relationship storing unit 16. In other words, the event relationship selecting unit 15 selects, out of the candidate event pairs, an event pair that has a high certainty factor as the event pair for the series texts and stores the selected event pair into the event relationship storing unit 16. In this situation, an arrangement is acceptable in which a targeted event that makes the highest certainty factor among the candidate event pairs is selected as the targeted event that should be paired with the targeting event. Another arrangement is acceptable in which a targeted event that makes the certainty factor of the candidate event pair equal to or larger than a predetermined threshold value is selected as the targeted event that should be paired with the targeting event. Yet another arrangement is acceptable in which, for each of the event classes into which mutually the same type of events are categorized, a targeted event that makes the highest certainty factor among the candidate event pairs is selected as the targeted event that should be paired with the targeting event.

In the present example, the event relationship selecting unit 15 finds a targeted event that makes the highest certainty factor among the candidate event pairs, for each of the event classes into which mutually the same type of events are categorized and determines that the targeted event that has been found is the targeted event that should be paired with the targeting event. For example, in the case where the element text t2 is the target element text, and the targeting event is “company A”, the event “not satisfied” is determined as the targeted event that should be paired with the targeting event “company A”, based on the certainty factors shown in FIG. 7.

As another example, in the case where the element text t2 is the target element text, and the targeting event is “company B”, the event “satisfied” is determined as the targeted event that should be paired with the targeting event “company B”, based on the certainty factors shown in FIG. 8.

As explained above, the processes at steps Sa5 to Sa9 are performed for each of the element texts that are included in the series texts so that, with respect to each of the events included in the element texts, a targeted event that should be paired with a targeting event is determined for each of the targeting events. When these processes have been performed for each of all the element texts that are included in the series texts, so that the result of the judgment process at step Sa6 is in the negative, and also the result of the judgment process at step Sa5 is in the negative, the process proceeds to step Sa10.

At step Sa10, the event relationship displaying unit 17 displays the event pairs stored in the event relationship storing unit 16 on the display device, and the process ends.

FIG. 9 is a drawing illustrating an example in which event pairs are displayed. As shown in FIG. 9, each of the event pairs for the series texts is displayed while being combined with a period of time in which the event pair occurs and the certainty factor of the event pair.

With the configuration explained above, it is possible to find the correspondence relationships among the plurality of events that are extracted from the element texts included in the series texts that have an ordinal structure. Thus, even if a plurality of items are written in a specific text, it is possible to find the correspondence relationship among the events in the text. Also, even if the correspondence relationships among the events change during the course of time, it is possible to find the correspondence relationships among the event at a certain point in time, while the lapse of time is taken into consideration. In the embodiment described above, one of the events that have not been extracted yet is extracted as the targeting event at step Sa6; however, another arrangement is acceptable in which it is possible to extract only the events that are included in a specific event class as the targeting event.

Also, at step Sa7, an event that is different from the targeting event and has not been extracted yet is extracted as the targeted event; however, another arrangement is acceptable in which a specific correspondence relationship is specified between the event class of the targeting event and the event class of the targeted event so that it is possible to extract, as the targeted event, only the events that are included in the event class that satisfies the specified correspondence relationship.

For example, in the case where the pieces of event extracting knowledge as shown in FIG. 3 are used, a correspondence relationship is specified in advance in which the event class of the targeting event is “customer evaluation”, whereas the event class of the targeted event is “company”, and the specified correspondence relationship is stored in the storage unit. In this situation, when the element text t2 is extracted as the target element text at step Sa5 described above, the event searching unit 13 generates, at step Sa7, candidate event pairs by referring to the stored correspondence relationship. As a result, in the present modification example, the combinations of (company A, company B) and (satisfied, not satisfied) are not generated as the candidate event pairs. With this arrangement, it is possible to generate only the candidate event pairs that are considered to have a high certainty factor.

Further, at step Sa9 in the exemplary embodiment described above, the event relationship selecting unit 15 determines the targeted event that should be paired with the targeting event for each of the event classes in which mutually the same type of events are categorized; however, the event relationship selecting unit 15 does not necessarily have to determine the targeted event for each of the event classes. For example, another arrangement is acceptable in which, in the case where “company A” is the targeting event, the event “company B” may also be determined as the targeted event that should be paired with the targeting event. As another example, in the case where “satisfied” is the targeting event, the event “not satisfied” may also be determined as the targeted event that should be paired with the targeting event.

In the exemplary embodiment described above, each of the event pairs is made up of two events that are namely a targeting event and a targeted event; however, another arrangement is acceptable in which each of the event pairs is made up of three or more events.

In the exemplary embodiment described above, the posted dates are used as the order information; however, another arrangement is acceptable in which times such as posted times are used as the order information instead of the dates.

Further, with the present invention, it is possible to process not only series texts in which the element texts are arranged in a total order according to the order information but also series texts in which the element texts are arranged in a partial order.

In the exemplary embodiment described above, the series texts are stored in the series text storing unit 10 in advance; however, another arrangement is acceptable in which the series texts are stored in a second information processing apparatus so that the information processing apparatus 1 obtains the series texts by downloading them from the second information processing apparatus via the communicating unit. Yet another arrangement is acceptable in which the series texts are recorded on a computer-readable recording medium such as a Compact Disk Read-Only Memory (CD-ROM), a Flexible Disk (FD), a Compact Disk Recordable (CD-R), a Digital Versatile Disk (DVD), or the like, so that the information processing apparatus further including a driver obtains the series texts stored in the recording medium by reading them via the driver.

Further, another arrangement is acceptable in which the various types of programs that are executed by the information processing apparatus 1 explained in the exemplary embodiment above are provided as being recorded on a computer-readable recording medium such as a CD-ROM, a Flexible Disk (FD), a CD-R, a Digital Versatile Disk (DVD), or the like, in a file that is in an installable format or in an executable format. Furthermore, yet another arrangement is acceptable in which the various types of programs are stored in a second information processing apparatus connected to a network such as the Internet, so that the programs are provided as being downloaded via the network.

In the exemplary embodiment described above, the candidate event pairs are generated for each of the element texts, and also, the certainty factors of the candidate event pairs are calculated for each of the element texts; however, the process to generate the candidate event pairs and the process to calculate the certainty factors do not necessarily have to be performed for each of the element texts.

In the exemplary embodiment described above, another arrangement is acceptable in which the inter-event certainty-factor calculating unit 14 calculates the distance between the element texts by using bibliographic information that is appended to the element texts. In this situation, the bibliographic information denotes, for example, information about the writers of the element texts, the titles of the element texts, and the categories of the element text.

Further, yet another arrangement is acceptable in which the anterior inter-element-text certainty factor is adjusted by using the bibliographic information. For example, in the case where the writer of the element text and the category of the element text are appended to each of the element texts as the bibliographic information, the event extracting-knowledge storing unit 11 is configured so as to store therein weights that respectively correspond to the writers and the categories. At step Sb2, the inter-event certainty-factor calculating unit 14 obtains a weight that corresponds to the writer and the category that are appended to the anterior element text by referring to the event extracting-knowledge storing unit 11. Accordingly, the inter-event certainty-factor calculating unit 14 is able to adjust the anterior inter-element-text certainty factor by multiplying the anterior inter-element-text certainty factor by the obtained weight. For example, let us discuss an example in which the element text t1 shown in FIG. 2 is the target text, and the element text t3 is the anterior element text, while the anterior inter-element-text certainty factor is “0.33”, and the writer Mr. x and the category p are given as the bibliographic information of the element text t3. Also, it is assumed that the event extracting-knowledge storing unit 11 stores therein a weight “0.9” for (x, p). In this situation, the inter-event certainty-factor calculating unit 14 multiples the anterior inter-element-text certainty factor “0.33” by the weight “0.9” corresponding to (x, p) and adjusts the anterior inter-element-text certainty factor so as to be “0.297”.

Furthermore, by following a procedure obtained by replacing the word “anterior” in the explanation above with the word “posterior”, it is possible to adjust the posterior inter-element-text certainty factor in a similar manner.

In addition, another arrangement is acceptable in which the distance between the element texts is calculated by using the number of element texts that are positioned between the target element text and the anterior element text or the volume of the element texts that are positioned between the target element text and the anterior element text.

For example, it is acceptable to define the anterior inter-element-text certainty factor by using Formula (4) below.

$$ANTERIOR INTER \text{-} ELEMENT - TEXT CERTAINTY FACTOR = 1 - \frac{\begin{matrix}NUMBER OF TEXTS UP TO \\ ANTERIOR ELEMENT TEXT\end{matrix}}{ANTERIOR MAXIMUM NUMBER OF TEXTS} \qquad ( 4 )$$

In Formula (4), the “anterior maximum number of texts” denotes the number of texts up to an element text that is away from the target element text at maximum. In this example, the term “anterior” means that the posted date that is included in the element text and serves as the order information has an older date, whereas the term “posterior” means that the posted date that serves as the order information has a more recent date. However, the opposite may be applied to the present modification example. For example, in the case where the element text t1 shown in FIG. 2 is the target text, and the element text t3 is the anterior element text, while the anterior maximum number of texts is “10”, the anterior inter-element-text certainty factor is calculated as “0.8” (=1-2/10).

As another example, it is acceptable to calculate the anterior inter-element-text certainty factor by using Formula (5) below.

$$ANTERIOR INTER \text{-} ELEMENT - TEXT CERTAINTY FACTOR = 1 - \frac{\begin{matrix}NUMBER OF CHARACTERS UP TO \\ CHARACTER IN ANTERIOR ELEMENT TEXT\end{matrix}}{\begin{matrix}ANTERIOR MAXIMUM NUMBER \\ OF CHARACTERS\end{matrix}} \qquad ( 5 )$$

In Formula (5), the “anterior maximum number of characters” denotes the number of characters up to the first character in the element text that is away from the first character of the target element text at maximum. For example, in the case where the element text t1 shown in FIG. 2 is the target text, and the element text t2 is the anterior element text, while the anterior maximum number of characters is “20”, because the element text t1 is made up of 12 characters, the anterior inter-element-text certainty factor is calculated as “0.4” (=1-12/20).

As yet another example, it is acceptable to define the anterior inter-element-text certainty factor by using Formula (6) below.

$$ANTERIOR INTER \text{-} ELEMENT - TEXT CERTAINTY FACTOR = 1 - \frac{1}{{( \begin{matrix}DIFFERENCE IN DATES FROM \\ ANTERIOR ELEMENT TEXT\end{matrix} + 1 )}^{α}} \qquad ( 6 )$$

In Formula (6), it is assumed that “α>0” is satisfied. For example, in the case where the element text t1 shown in FIG. 2 is the target text, and the element text t3 is the anterior element text, while “α=1” is satisfied, the anterior inter-element-text certainty factor is calculated as “0.14” (=1/(6+1)).

As yet another example, it is acceptable to define the anterior inter-element-text certainty factor by using Formula (7) below.

$$ANTERIOR INTER \text{-} ELEMENT - TEXT CERTAINTY FACTOR = 1 - \frac{1}{{( \begin{matrix}NUMBER OF TEXTS UP TO \\ ANTERIOR ELEMENT TEXT\end{matrix} + 1 )}^{α}} \qquad ( 7 )$$

In Formula (7), it is assumed that “α>0” is satisfied. For example, in the case where the element text t1 shown in FIG. 2 is the target text, and the element text t3 is the anterior element text, while “α=1” is satisfied, the anterior inter-element-text certainty factor is calculated as “0.33” (=1/(2+1)).

As yet another example, it is acceptable to define the anterior inter-element-text certainty factor by using Formula (8) below.

$$ANTERIOR INTER \text{-} ELEMENT - TEXT CERTAINTY FACTOR = 1 - \frac{1}{{( \begin{matrix}NUMBER OF CHARACTERS UP TO FIRST \\ CHARACTER IN ANTERIOR ELEMENT TEXT\end{matrix} + 1 )}^{α}} \qquad ( 8 )$$

In Formula (8), it is assumed that “α>0” is satisfied. For example, in the case where the element text t1 shown in FIG. 2 is the target text, and the element text t2 is the anterior element text, while “α=1” is satisfied, because the element text t1 is made up of 12 characters, the anterior inter-element-text certainty factor is calculated as “0.077” (=1/(12+1)).

Further, by performing calculations using expressions obtained by replacing the word “anterior” in Formulas (4) to (8) presented above with the word “posterior”, it is possible to define the posterior inter-element-text certainty factor in a similar manner.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
an obtaining unit that obtains a text from a text set including a plurality of texts each of which is constituted by a character string and that can be arranged in an order;
a first storage unit that stores an event extracting knowledge used for extracting from the text a plurality of events by which contents of the text are characterized;
an extracting unit that extracts a plurality of events from the obtained text by using the event extracting knowledge;
a generating unit that extracts a targeting event from the plurality of events and one or more targeted events from the plurality of events other than the targeting event, and generates one or more combinations of the targeting event and the targeted events;
a calculating unit that calculates a distance indicating a difference in closeness in terms of the order between a first text from which the combination has been generated and a second text from which the combination has been generated, and calculates, for each of the combinations, a certainty factor indicating a degree of certainty of the combination of the targeting event and the targeted event in such a manner that the shorter the distance is, the higher a value of the certainty factor is;
a selecting unit that selects, as a combination for the text set, one of a first combination and a second combination, the first combination having the certainty factor calculated by the calculating unit that is equal to or larger than a threshold value, and the second combination having the certainty factor placed in an ordinal rank equal to or lower than a predetermined ordinal rank; and
a display controlling unit that causes a displaying unit to display the selected combination.

2. The apparatus according to claim 1, wherein
the plurality of texts are arranged in the order based on date/time information that is in correspondence with each of the texts and indicates at least one of a date and a time, and
the calculating unit calculates the distance by using a difference between a first date/time indicated by first date/time information that is in correspondence with the first text and a second date/time indicated by second date/time information that is in correspondence with the second text, and calculates the certainty factor for each of the combinations.

3. The apparatus according to claim 1, wherein the calculating unit calculates the certainty factor for each of the combinations by using the calculated distance and a maximum distance specified in advance.

4. The apparatus according to claim 2, wherein the calculating unit includes
a first calculating unit that calculates the distance by using a difference between the first date/time and a third date/time and calculates a first certainty factor for each of the combinations, the first date/time being indicated by the first date/time information that is in correspondence with the first text, and the third date/time being older than the first date/time and being indicated by third date/time information that is in correspondence with a third text from which one or more of the combinations have been generated,
a second calculating unit that calculates the distance by using a difference between the first date/time and a fourth date/time and calculates a second certainty factor for each of the combinations, the first date/time being in correspondence with the obtained text, and the fourth date/time being more recent than the first date/time and being indicated by fourth date/time information that is in correspondence with a fourth text from which one or more of the combinations has been generated, and
a third calculating unit that calculates the certainty factor by using the first certainty factor and the second certainty factor.

5. The apparatus according to claim 1, wherein the calculating unit calculates the distance by using a difference between an ordinal position of the first text and an ordinal position of the second text and calculates the certainty factor for each of the combinations, the ordinal positions being based on the order in which the plurality of texts are arranged.

6. The apparatus according to claim 1, wherein the calculating unit calculates the distance by using a difference indicating the number of characters between a start of a character string constituting the first text and a start of a character string constituting the second text within an arrangement of the plurality of texts that are arranged in the order, and calculates the certainty factor for each of the combinations.

7. The apparatus according to claim 1, wherein
the event extracting knowledge indicates a correspondence relationship between a characteristic character string representing a characteristic expression and the events, and
the extracting unit extracts the events that correspond to the characteristic character string when the obtained text includes the characteristic character string indicated in the event extracting knowledge.

8. The apparatus according to claim 7, wherein
the event extracting knowledge further indicates event classes showing types of the events in correspondence with each of the events, and
the generating unit extracts one of the events from the plurality of events extracted from the text as the targeting event, extracts, as the targeted events, one or more of the events each of which belongs to an event class different from an event class to which the targeting event belongs, and generates one or more of the combinations.

9. The apparatus according to claim 7, further comprising:
a second storage unit that stores a correspondence relationship between an event class to which the event extracted as the targeting event belongs and an event class to which each of the one or more events extracted as the targeted events belongs, wherein
the generating unit extracts the targeting event and the targeted events and generates one or more of the combinations by using the correspondence relationship stored in the second storage unit.

10. The apparatus according to claim 1, wherein the selecting unit selects one of the combinations that has a highest certainty factor.

11. The apparatus according to claim 1, further comprising a third storage unit that stores the selected combination, wherein
the display controlling unit causes the displaying unit to display the combination stored in the third storage unit.

12. An information processing method comprising:
obtaining, by an obtaining unit of an information processing apparatus, a text from a text set including a plurality of texts each of which is constituted by a character string and that can be arranged in an order;
extracting, by an extracting unit of the information processing apparatus, from the obtained text a plurality of events by using the event extracting knowledge used for extracting from the text the event that is stored in a first storage unit and characterizes contents of the text;
extracting, by a generating unit of the information processing apparatus, a targeting event from the plurality of events and one or more targeted events from the plurality of events other than the targeting event, and generating one or more combinations of the targeting event and the targeted events;
calculating, by a calculating unit of the information processing apparatus, a distance indicating a difference in closeness in terms of the order between a first text from which the combination has been generated and a second text from which the combination has been generated, and calculating, for each of the combinations, a certainty factor indicating a degree of certainty of the combination of the targeting event and the targeted event in such a manner that the shorter the distance is, the higher a value of the certainty factor is;
selecting, by a selecting unit of the information processing apparatus, as a combination for the text set, one of a first combination and a second combination, the first combination having the certainty factor calculated by the calculating unit that is equal to or larger than a threshold value, and the second combination having the certainty factor placed in an ordinal rank equal to or lower than a predetermined ordinal rank; and
causing, by a display controlling unit of the information processing apparatus, a displaying unit to display the selected combination.

13. A computer program product having a computer readable medium including programmed instructions for processing information, wherein the instructions, when executed by a computer, cause the computer to perform:
obtaining a text from a text set including a plurality of texts each of which is constituted by a character string and that can be arranged in an order;
extracting from the obtained text a plurality of events by using the event extracting knowledge used for extracting from the text the event that is stored in a first storage unit and characterizes contents of the text;
extracting a targeting event from the plurality of events and one or more targeted events from the plurality of events other than the targeting event, and generating one or more combinations of the targeting event and the one or more targeted events;
calculating a distance indicating a difference in closeness in terms of the order between a first text from which the combination has been generated and a second text from which the combination has been generated, and calculating, for each of the combinations, a certainty factor indicating a degree of certainty of the combination of the targeting event and the targeted event in such a manner that the shorter the distance is, the higher a value of the certainty factor is;
selecting, as a combination for the text set, one of a first combination and a second combination, the first combination having the certainty factor calculated by the calculating unit that is equal to or larger than a threshold value, and the second combination having the certainty factor placed in an ordinal rank equal to or lower than a predetermined ordinal rank; and
causing a displaying unit to display the selected combination.
